(19) United States
(12) Patent Application Publication
(10) Pub. No.: US 2002/0022164 A1
(43) Pub. Date: Feb. 21, 2002

(54) Fuel cell having an internal reformation unit and a cell with a cation-conducting electrolyte membrane

(76) Inventor: Berthold Keppeler, Owen (DE)

Correspondence Address: CROWELL & MORING, L.L.P., P.O. Box 14300, Washington, DC, 20044-4300, US

(21) Appl. No.: 09/902,945

(22) Filed: Jul. 11, 2001

(30) Foreign Application Priority Data
Jul. 11, 2000 (DE) 100 33 594.2-45

(51) Int. Cl. H01M 8/06; H01M 8/10

(52) U.S. Cl. 429/20; 429/30; 429/32

(57) ABSTRACT

A fuel cell includes at least one internal reformation unit and at least one individual cell having an electrolyte membrane, an anode, and a cathode. The at least one individual cell makes indirect thermal conduct with the at least one reformation unit. The electrolyte membrane is a material that conducts cations.

### BACKGROUND AND SUMMARY OF INVENTION

This application claims the priority of German Application No. 100 33 594.2, filed Jul. 11, 2000, the disclosure of which is expressly incorporated by reference herein.

The present invention relates to a fuel cell having at least one internal reformation unit and at least one individual cell having an electrolyte membrane.

Fuel cells for supplying power to dwellings and motor vehicles (Ullmann's Encyclopedia of Technical Chemistry Volume 12, pages 113-136, Verlag Chemie, Weinheim 1976) are increasingly becoming the subject of numerous experiments.

Fuel cells produce electrical power by direct energy conversion from chemical energy as the inverse of water electrolysis. In this case, a fuel cell has at least one individual cell which comprises two invariant electrodes (cathode and anode) between which an invariant electrolyte is located. The fuel cell supplies current by continuously supplying a substance (fuel) to be oxidized, for example hydrogen, to the anode and an oxidant, for example air, to the cathode, and carrying away the oxidation products continuously.

Various fuel cell types are known which are distinguished in particular by the nature of their electrolyte, that is by the nature of the ion which transports the electricity through the electrolyte. This also affects the operating temperature of the fuel cells. For example, fuel cells (FC) with electrolytes composed of molten carbonate (MCFC) or of oxide ceramics (SOFC) are in general operated at temperatures between 600 and 1050° C. Fuel cells with alkaline electrolytes (AFC), electrolytes composed of polymer membranes (PEMFC), or phosphoric acids (PAFC) in contrast have operating temperatures between 0 and 200° C. Polymer membranes in particular are being used increasingly for widely differing applications, due to their low weight and their simple prefabrication.

Fuel cells are normally operated with hydrogen as the fuel, but hydrogen can be stored only with difficulty. Hydrogen is therefore generally stored in the form of liquid hydrocarbon compounds, which conventionally include alcohols, aldehydes, ketones, and the like. These compounds are split into hydrogen and CO₂ in a gas generation unit.

Hydrogen generation in a gas generation unit takes place essentially in the form of two chemical reactions, which can be carried out either individually or in combination.

One reaction is referred to as a reformation reaction or steam reformation which, if methanol is being used as a hydrogen store, takes place in accordance with equation (I):

CH₃OH+xH₂O→3H₂+x−1H₂O+CO₂ (I)

The other reaction is referred to as partial oxidation (POX) and, for methanol, takes place in accordance with equation (II):

CH₃OH+½O₂→2H₂+CO₂ (II)

The combination of both reactions leads to an autothermal method of operation.

Carbon monoxide is also produced at the same time, in addition to carbon dioxide, in both reactions via the hydrogen-shift equilibrium reaction (III):

CO₂+H₂⇄CO+H₂O (III)

This parasitic reaction (III), which consumes part of the hydrogen that is produced, shifts to the right-hand side of the reaction equation at high temperatures, and reduces the hydrogen yield. Furthermore, larger quantities of carbon monoxide are produced, and this poisons the electrodes and has to be removed from the overall process in a complex manner.

The energy required for a gas generation unit to produce hydrogen, in particular for the reformation reaction in a reformation unit, can be supplied to the gas generation unit in various ways.

The required heat can be produced in a catalytic burner and/or during the selective carbon monoxide reduction. However, it is also possible to start an exothermic POX reaction first of all and to carry out the reformation reaction afterwards.

In addition, fuel cells may have what is referred to as an internal reformer. In this case, the heat released by the exothermic fuel cell reaction is used in order to supply the reformation unit with the heat required for the reformation reaction. This can be achieved by physically different arrangements of the reformation unit and the fuel cell, which are referred to as direct internal reformation and indirect internal reformation.

For example, DE 198 15 209 A1 describes a PEM fuel cell which has a direct internal reformation unit. This means that the reformation unit is arranged in the anode gas chamber of the fuel cell. However, the reformation catalytic converter is subject to increased wear and to deactivation by the gases in the anode chamber, so that it has to be replaced after relatively short operating times. Further, PEM fuel cells are generally operated at approximately 80° C., since the membrane decomposes at higher temperatures. However, this leads to a reduced reaction rate and hence to a reduced output. A further problem is monitoring of the reaction temperature which, as stated above, leads to decomposition of the membrane if a limit value is exceeded. The fuel cell therefore needs to be cooled, which necessitates an additional cooling system and results in poor fuel cell efficiency.

Owing to the temperature sensitivity of the electrolyte membrane in PEM fuel cells, an initial feeling has arisen among specialists that indirect internal reformation is feasible only with the interposition of complex cooling systems in order to compensate for the different temperature levels between the fuel cell (approximately 80° C.) and the reformation unit (approximately 250 to 300° C.).

U.S. Pat. No. 5,348,814, incorporated by reference in its entirety, discloses a fuel cell having an electrolyte membrane composed of molten carbonate (MOFC) and having an indirect internal reformation unit. A reformation unit is arranged in direct thermally conductive contact between two individual cells. The aim of this configuration is to ensure an operating temperature which is as high as possible and is approximately 650° C., with regard to high reaction rate. This arrangement can be used only for fuel cells which are stable at high temperatures and have membranes composed of molten carbonate (MCFC) or oxide ceramics (SOFC). An additional downstream gas purification unit or CO burner is often required for this version of reaction control.

However, gas purification systems result in problems in automated process control, enlarge the system volume and the mass of a fuel cell, and require costly catalytic converters containing noble metals. Furthermore, they reduce the overall efficiency of a gas generation unit. Even after purification, there are always relatively large amounts of carbon monoxide remaining in the system, which adversely affect the electricity generation by poisoning the fuel cell electrodes which, in general, contain platinum.

Surprisingly, it has now been found that the fuel cell according to the present invention is not subject to the described disadvantages of the prior art.

According to the present invention, at least one individual cell having an electrolyte membrane which conducts cations is arranged in indirect thermal contact with at least one reformation unit. Since a membrane which conducts cations is sufficiently temperature-stable, the heat emitted from the individual cell can be transmitted directly to the reformation unit. There is thus no need for a separate cooling circuit. The heat emitted from the fuel cell can be used directly, and is no longer lost. Overall, this improves the system energy efficiency.

The indirect thermal contact allows the operating temperature of the reformation unit to be reduced. This first of all results in a reduced “turnover” (output per unit quantity of catalytic converter) from the reformation catalytic converter, since the reformation reaction is kinetically controlled. However, the reduced load and the lower temperature at which the reaction takes place lead to a considerable improvement in the ageing behavior of the reformation catalytic converter.

The term “reformation unit”, as it is used in the following text, covers any apparatus by which hydrogen can be obtained from a hydrocarbon as defined above.

A material is defined as conducting cations if an electrically conductive connection can be produced between the anode and the cathode of a fuel cell by cation migration.

The term “indirect thermal contact” means that the at least one reformation unit and at least one individual cell in the fuel cell are arranged such that they are physically adjacent to one another and in thermally conductive contact with one another and that there is no cooling system between the reformation unit and the individual cell in the fuel cell.

The electrolyte membrane is advantageously stable up to 300° C. This allows a fuel cell according to the present invention to have operating temperatures in a temperature range from 50 to 300° C., preferably from 100 to 200° C. According to equation (III), this leads to a reduced amount of carbon monoxide being produced in the reformation unit, and at the same time reduces the sensitivity of the electrodes in the fuel cell to carbon monoxide.

The reduction in the carbon monoxide output concentration from the reformation unit from the fuel cell means that there is no need for a downstream gas purification system, for example by means of selective oxidation, and this leads to a reduction in the weight and volume of the fuel cell system according to the present invention.

The membrane preferably conducts protons, so that it is possible to use a large number of materials which are readily available and conduct protons.

In one embodiment, the electrolyte membrane is composed of a polymer. A polymer is at the same time used as a barrier for the gases which are produced in the anode area and which would otherwise migrate to the cathode. Further, a polymer is flexible, is largely resistant to fracture, and has low weight.

In another embodiment, the electrolyte membrane is composed of carbon and/or ceramic materials, together with combinations of these materials. Membranes such as these are particularly temperature-stable and can thus withstand temperature peaks which occur suddenly in the fuel cell without any risk of decomposition.

It is advantageous for an individual cell in the fuel cell to be arranged between two reformation units, thus resulting in a structure analogous to a heat exchanger, so that heat is transferred efficiently.

In another embodiment, one reformation unit is arranged between two individual cells in the fuel cell. This version also results in a structure analogous to a heat exchanger, and the heat transfer of the heat emitted from the individual cells to the reformation unit is particularly efficient.

In another embodiment, the fuel cell is designed in such a way that the reformation unit can be used both for a steam reformation reaction according to equation (I) and for a partial oxidation reaction (POX) according to equation (II). Thus, if the fuel cell is started from cold, the reformation unit can initially be used as POX reactor according to equation (II), which produces the necessary heat to allow the fuel cell to be raised to its operating temperature. A transition to the steam reformation reaction according to equation (I) can then be carried out. Cold starting of a fuel cell according to the present invention is thus considerably shortened.

A fuel cell according to the present invention is preferably used in mobile systems, for example motor vehicles. This is due to the small amount of space required by it, as described above, and its low weight. Furthermore, a fuel cell according to the present invention can be operated considerably more easily, in terms of control/regulation and metering, due to its lack of a gas purification unit.

It is self-evident that the features mentioned above and those which are still to be explained in the following text can be used not only in the respectively stated combination but also in other combinations or on their own, without departing from the context of the present invention.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic embodiment of a fuel cell according to the present invention; and

FIG. 2 shows a functional diagram of a fuel cell according to the present invention.

### DETAILED DESCRIPTION OF THE DRAWINGS

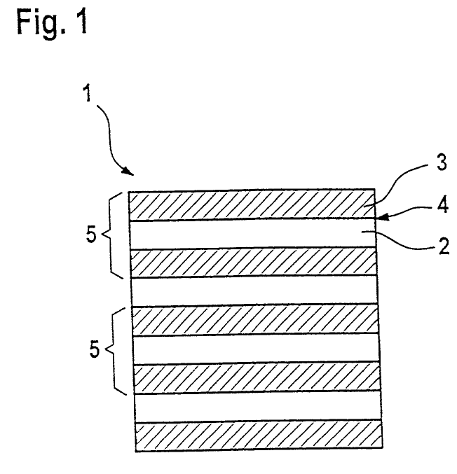

FIG. 1 shows a schematic embodiment of a fuel cell 1 according to the present invention. The fuel cell essentially comprises a sequence of a number of unit cells 5. There may be any desired number of successive unit cells 5 in this sequence, depending on the respective operational circumstances. Thus, a specifically adapted cell stack can be easily produced.

Each unit cell 5 comprises an individual cell 2 which is arranged between two reformation units 3 and makes indirect thermal contact with them. In another preferred embodiment, a unit cell 5 comprises two individual cells 2, between which one reformation unit 3 is arranged, which makes indirect thermal contact with the individual cells 2. The indirect thermal contact is made via contact areas 4. The indirect thermal contact is, for example, in the form of a heat exchanger. A large-area, thermally conductive contact is also feasible.

The individual cell 2 essentially comprises two invariant electrodes (cathode and anode) between which an electrolyte which conducts cations is located. The electrode material is essentially one or more noble metals selected from the first, second, and seventh to tenth subgroups of the periodic table of the elements, for example platinum, ruthenium, or one or more of these metals in combination with carbon and/or modified carbon. The electrolyte, which conducts cations, is a polymer, for example modified Nafion®, PEAK® or GORE®; a ceramic material which conducts cations and/or protons; or correspondingly modified carbon, for example, graphite doped with metals.

The reformation units 3 have a reformation catalytic converter, for example copper or a material containing copper. The rest of the reformation unit may be designed as required and depends on the field of operation of the fuel cell, for example in stationary or mobile systems. The reformation unit 3 may, of course, also have a vaporization unit, which is not illustrated but is known per se, for the educts to be reformed, as is described, for example, in German Patent Documents DE 195 34 433 C1 and DE 197 20 294 C1.

A further reformation unit 3 is arranged between each of the unit cells 5. However, other design solutions which are known to the average person skilled in the art are also feasible, such as thermally conductive bodies in the form of plates, and the like.

The fuel cell 1 according to the present invention allows the heat emitted from the fuel cell to be used directly by the reformation units 3 and does not result in any energy loss from the overall system. For example, in mobile systems, the load on a vehicle cooler is reduced. There is no need for any additional cooling circuit, as in the case of conventional fuel cells. The fuel cell according to the present invention thus improves the energy efficiency of the overall fuel cell system.

The fuel cell 1 is operated at approximately 100 to 200° C. since virtually all the heat emitted is supplied to the reformation units 3. This results in the electrodes being less sensitive to carbon monoxide since the formation of carbon monoxide surface layers is suppressed and less carbon monoxide is produced.

In consequence, the concentration of carbon monoxide that is emitted falls owing to the corresponding, comparatively low operating temperature in the reformation unit. There is thus no need for any downstream gas purification unit, for example by selective oxidation. This leads to a further advantageous system simplification.

The reformation units 3 are thus operated with electrolyte membranes which conduct purely protons at lower temperatures than in other known fuel cells. This admittedly results in the amount of catalytic converter that is required increasing through the slower reaction kinetics, but this also results in a reduction in the load on the catalytic converter (turnover rate, output per unit amount of catalytic converter). Both lead to an improvement in the ageing behavior of the reformation catalytic converter.

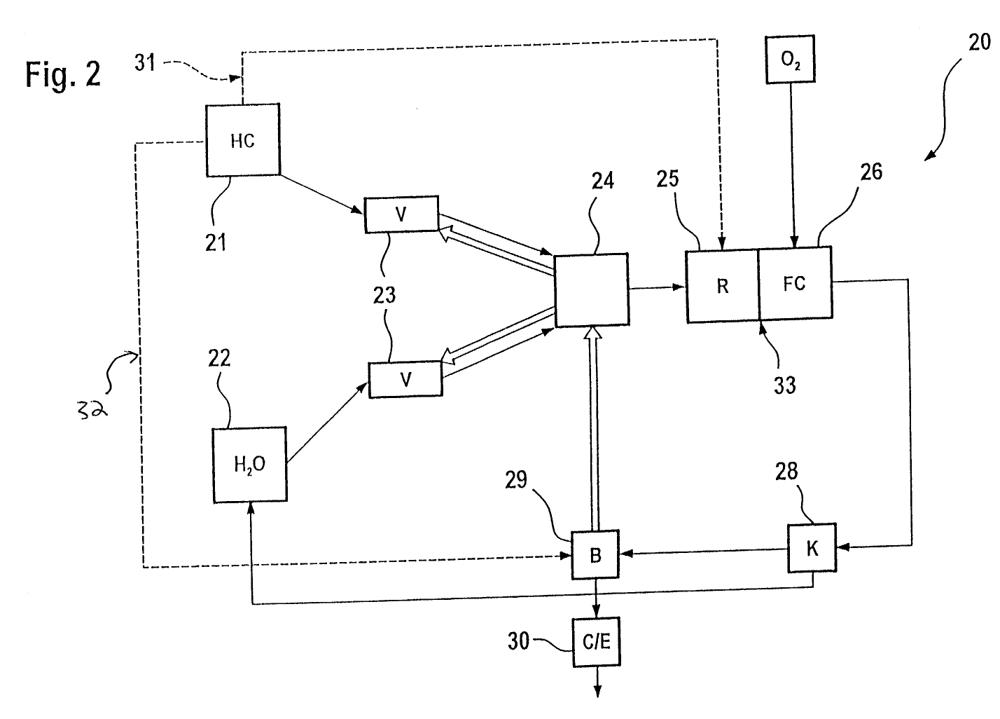

FIG. 2 shows a functional diagram of a fuel cell system 20 according to the present invention. The solid single arrows represent material transport, and the double arrows represent energy transport.

The fuel cell system 20 has a hydrocarbon reservoir (HC) 21 and a water reservoir (H₂O) 22. Hydrocarbon and water are changed to the vapor phase separately from one another in two vaporizers 23. Joint vaporization of water and hydrocarbon is also, of course, feasible, in one or more vaporizers 23. The combined vapors are then supplied to a superheater 24, and then to a reformation unit 25. In the same way, it is also possible to supply the vapors directly to the reformation unit 25, without any superheater 24. Likewise, only one educt may be supplied in the form of vapor, and the other in the liquid phase, to the reformation unit 25, as well. There may, of course, also be a number of reformation units 25, in a further embodiment.

The reformation unit 25 makes indirect thermally conductive contact with an individual cell 26, which has an electrolyte membrane that conducts cations, via contact area 33. As explained in conjunction with FIG. 1 above, this may be done in various ways. A freely selectable sequence comprising a number of reformation units 25 and individual cells 26 is, of course, also possible. The product gas produced in the fuel cell reaction is supplied to a condenser 28, which separates out the water contained in it and passes this to the water reservoir 22. Normally, the product gas from the reformation unit contains up to 2% by volume of carbon monoxide, but the fuel cell system 20 according to the present invention now contains only 0.2 to 0.3% by volume. This can be converted further in an optional catalytic burner (B) 29. From there, the outgas is passed into a compressor/expander (C/E) 30 and then to the environment.

It is now also possible to start the fuel cell system 20 according to the present invention from cold via the reaction process 32 illustrated by the dashed arrow:

In this case, the hydrocarbon is converted in the catalytic burner 29, which supplies the reaction heat produced in this way, by measures which are known per se, to the superheater 24 and/or to the vaporizer or vaporizers 23, as a result of which the reformation reaction can be started without any loss of energy.

The present invention also provides for the reformation unit 25 to be operated initially as a POX reactor, which is known per se. The reformation unit 25 is in this case supplied in advance with vaporized educt, for example a hydrocarbon or a hydrocarbon/water mixture. The fuel cell system 20 is then raised to its operating temperature by an exothermic partial oxidation reaction of the hydrocarbon according to equation (II).

A further advantage of the fuel cell system 20 according to the present invention is that the reformation unit 25 can also be operated with all the fuel being converted. In this case, the fuel which remains in the reformate after the reformation unit 25 is either condensed out and is hence recovered. Alternatively, fuel which has not been converted is supplied with the reformate to the fuel cell 26, where it is converted directly owing to the increased operating temperature. If, for example, methanol is used as the fuel, then this corresponds to partial operation as a direct methanol fuel cell (DMFC). This mode of operation with incomplete fuel conversion furthermore has the advantage that, if the reformation unit 25 is overloaded, less carbon monoxide is produced since the chemical equilibrium cannot occur.

In order to simplify the construction, the fuel cell system 20 can also be operated at ambient pressure. In this case, there would be no need for the compressor/expander (C/E) 30. This would be advantageous with regard to costs. At the same time, this would also reduce the risk of the previously vaporized educts condensing out in the reformation unit 25 due to the thermal contact with the cathode area of the fuel cell 26.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell, comprising:
at least one internal reformation unit;
at least one individual fuel cell having a cation-conducting electrolyte membrane, an anode, and a cathode,
wherein the at least one individual fuel cell is arranged in indirect thermal contact with the at least one reformation unit.

2. A fuel cell according to claim 1, wherein the cation-conducting electrolyte membrane is temperature-stable up to 300° C.

3. A fuel cell according to claim 1, wherein the cation-conducting electrolyte membrane conducts protons.

4. A fuel cell according to claim 3, wherein the cation-conducting electrolyte membrane comprises a polymer.

5. A fuel cell according to claim 3, wherein the cation-conducting electrolyte membrane comprises at least one of carbon or a ceramic material.

6. A fuel cell according to claim 1, comprising at least one unit cell which comprises an individual fuel cell arranged between two reformation units.

7. A fuel cell according to claim 1, comprising at least one unit cell which comprises a reformation unit arranged between two individual fuel cells.

8. A fuel cell according to claim 6, wherein the fuel cell has at least two unit cells.

9. A fuel cell according to claim 1, wherein the reformation unit is a steam reformation reactor and a partial oxidation reactor.

10. A fuel cell unit, comprising:
at least one reformation unit;
at least one individual fuel cell having a cation-conducting electrolyte membrane, an anode, and a cathode,
wherein the at least one individual fuel cell is separate from and in thermal contact with the at least one reformation unit, and
wherein the fuel cell unit does not include a cooling system or a gas purification system.

11. A motor vehicle having a fuel cell according to claim 1.

12. A method of operating a fuel cell unit, comprising:
vaporizing water and a hydrocarbon;
feeding the vaporized water and hydrocarbon to a reformation unit;
reforming the hydrocarbon, thereby producing hydrogen;
feeding the hydrogen to a fuel cell comprising a cation-conducting electrolyte membrane, an anode, and a cathode;
feeding an oxidant to the fuel cell; and
operating the fuel cell at a temperature of 50-300° C., thereby producing an electric current,
wherein the reformation unit and the fuel cell are separate chambers and are in thermal contact,
wherein no cooling occurs.

13. A method according to claim 12, further comprising, during a cold start of the fuel cell unit, operating the reformation unit as a partial oxidation reactor.
